(19) United States
(12) Patent Application Publication
(10) Pub. No.: US 2026/0243654 A1
(43) Pub. Date: Aug. 20, 2026

(54) Apparatus and method for examining surfaces with high-resolution image recording

(71) Applicant: BYK-Gardner GmbH, Geretsried (DE)

(72) Inventors: Uwe SPERLING, Geretsried (DE); Stefan KIRNER, Holzheim (DE); Mathias ZOLLBRECHT, Egenhofen (DE); Ulrich NEUHÄUSLER, Diedorf (DE)

(21) Appl. No.: 19/447,945

(22) Filed: Jan. 13, 2026

(30) Foreign Application Priority Data
Feb. 14, 2025 (DE) 10 2025 105 601.3

(51) Int. Cl. G01N 15/1434; G02B 21/18; G02B 21/36

(52) U.S. Cl. CPC G01N 15/1434; G02B 21/18; G02B 21/361

(57) ABSTRACT

An apparatus for examining optical properties of surfaces, includes a first radiation device which is configured to irradiate radiation onto the surface to be examined in a first irradiation direction characterized by a first irradiation angle, a second radiation device which is configured to irradiate radiation onto the surface to be examined in a second irradiation direction characterized by a second irradiation angle, and with a first image recording device which is configured for recording a spatially resolved image of the surface irradiated by at least one of the irradiation devices, wherein the apparatus has a second image recording device which is configured for recording a spatially resolved image of the surface and, in particular, of the surface irradiated by at least one of the irradiation devices.

### CROSS REFERENCE TO RELATED APPLICATION

This application claims benefit to German Patent Application Serial No. 10 2025 105 601.3, filed Feb. 14, 2025, the contents of which are incorporated herein by reference.

### BACKGROUND OF THE INVENTION

The present invention relates to an apparatus and a method for examining surface properties. The present invention is described with reference to the surfaces of motor vehicles, but it should be noted that the invention is also applicable to other surfaces, such as the surfaces of furniture.

So-called multi-angle measuring devices have long been known in the prior art, in which radiation, and in particular visible light, is irradiated onto the surface to be examined from different directions and the radiation scattered and/or reflected by the surface is analyzed and/or images of the irradiated or illuminated surface are recorded.

For this purpose, it is known that several radiation devices are provided in a housing, which irradiate the surface with radiation, in particular light, from different angles. In addition, an image camera is often provided, which serves to record images of the surface illuminated by the individual radiation devices.

So-called effect pigment coatings have been known in the prior art for some time. These contain effect pigments within the actual coating layer or in a layer, which in turn alter the optical impression of the surface. Such effect pigment layers are sometimes more difficult to detect optically and, in particular, more difficult to categorize than conventional surfaces. In addition, the visual impression of such effect pigment layers also changes significantly depending on the direction of illumination and the direction of observation.

For this reason, various methods and apparatuses have already been described that enable a more objective assessment of these effect pigment surfaces.

Nevertheless, it would be desirable to characterize these surfaces more precisely.

The present invention is therefore based on the object of improving the evaluation of such surfaces and also enabling a more precise examination of these surfaces.

### SUMMARY OF THE INVENTION

An apparatus according to the invention for examining optical properties of surfaces, and in particular surfaces containing effect pigments, has a first radiation device which is suitable and intended to irradiate radiation (and in particular light, and in particular light in the visible wavelength range) onto the surface to be examined in a first irradiation direction characterized by a first irradiation angle. In addition, a second radiation device is provided which is suitable and intended to irradiate radiation (and in particular light and in particular light in the visible wavelength range) onto the surface to be examined in a second irradiation direction characterized by a second irradiation angle.

Furthermore, a first image recording device is provided which is suitable and intended to record a spatially resolved image of the surface irradiated and/or illuminated by at least one of the irradiation directions.

According to the invention, the apparatus has a second image recording device which is suitable and intended to record a (in particular, further) spatially resolved image of the surface and, in particular, of the surface irradiated and/or illuminated by at least one of the irradiation devices.

An apparatus is therefore proposed which uses (at least) two image recording devices, wherein these image recording devices preferably have different resolutions and/or enable images of the surface to be recorded with different resolutions (and/or different enlargements of the recorded image relative to the surface).

A further apparatus according to the invention for examining optical properties of surfaces that have effect pigments has a first radiation device that is suitable and intended to irradiate radiation (and in particular light, and in particular light in the visible wavelength range) onto the surface to be examined in a first irradiation direction characterized by a first irradiation angle.

In addition, a second radiation device is preferably provided, which is suitable and intended to irradiate radiation (and in particular light and in particular light in the visible wavelength range) onto the surface to be examined in a second irradiation direction characterized by a second irradiation angle.

In addition, a first image recording device is provided which is suitable and intended to record a spatially resolved image of the surface and, in particular, of the surface irradiated by the irradiation device.

According to the invention, the apparatus has a second image recording device which is suitable and intended to record a spatially resolved image of the surface and, in particular, of the surface irradiated by the (at least one) irradiation device, as well as an evaluation device which is suitable and intended to evaluate the image recorded by the second image recording device in order to determine at least one property which is characteristic of the effect pigments and/or the individual effect pigments.

It is therefore proposed in both methods that the surface be observed with two image recording devices. In the second case, properties, in particular of the effect pigments, are determined on the basis of the image (or images).

In a further preferred embodiment, the surface has so-called effect pigments, as mentioned above. Within the scope of the invention, it is therefore proposed that the recorded image be (highly) resolved in such a way that the effect pigments can be observed at least in groups and preferably individually.

In a preferred embodiment, the first image recording device and the second image recording device are arranged in such a way that they observe the same area of the illuminated surface or record an image thereof.

However, it would also be conceivable for the second image recording device to record an image of a different area of the surface than the first image recording device, and in particular of an area that is offset laterally from the area recorded by the first image recording device. A displacement is preferably less than 10 cm, preferably less than 8 cm, preferably less than 6 cm, and particularly preferably less than 5 cm. A displacement is preferably greater than 0.5 cm, preferably greater than 1.0 cm, and particularly preferably greater than 2.0 cm.

Preferably, the second image recording device has an autofocus unit and/or is designed as an autofocus camera module. This can be the case regardless of where the second image recording device is located.

The first image recording device may also have an autofocus unit.

In a further preferred embodiment, the second image recording device has a further illumination device which illuminates an area of the surface from which an image is recorded by the second image recording device. This may be a ring-shaped lighting in particular.

In this configuration, it is proposed that the second image recording device be preferably designed as a separate unit. On the one hand, this means that the first image recording device and the second image recording device record different areas of the surface. On the other hand, however, it also means that beam splitter units, which are provided when the same section of the surface is to be recorded and/or recorded at the same angle, can be dispensed with.

In a further preferred embodiment, the apparatus has a further detection device which is suitable and intended to detect radiation emitted by the radiation device and reflected by the surface. This may be a detection device which is suitable and intended to detect an intensity and/or a wavelength of the radiation reflected by the surface.

In a further preferred embodiment, the apparatus has a further detection device which is suitable and intended to detect an intensity of the radiation scattered by the surface.

In a further preferred embodiment, the first and preferably at least one radiation device is suitable and intended to emit radiation in different colors. For example, it is possible to use LEDs that can emit light of different wavelengths. However, it would also be conceivable to use filters arranged in the beam path between a light source, for example a white light source (such as one or several LEDs), and the surface to be examined. In this way, a control device can control the irradiation of the surface in different colors and, in particular, in the visible wavelength range.

In a further preferred embodiment, the first radiation device has a light source and a plurality of color filter devices which can be selectively moved into a beam path between the light source and the surface to be examined. Particularly preferably, the radiation device has a filter wheel which can be rotated about a predetermined axis of rotation and on which the color filter devices are arranged.

However, it would also be conceivable for such filter elements to be movable into the beam path between the surface and at least one detection device and/or image recording device.

In a further advantageous embodiment, the apparatus has a second radiation detection device which is suitable and intended to detect radiation emitted and, in particular, scattered from the surface to be examined at a second emission angle in response to the irradiated radiation.

Particularly preferably, the apparatus has a further radiation detection device which is suitable and intended to record radiation emitted and, in particular, scattered from the surface to be examined in response to the irradiated radiation at a further emission angle.

Preferably, an image recording device, and preferably both image recording devices are arranged in such a way that they record radiation emitted in a vertical direction (relative to the surface to be examined) from the surface to be examined.

Preferably, at least one of the image recording devices is an image camera and, in particular, a color image camera. Particularly preferably, both image recording devices are color image cameras.

In a further preferred embodiment, the second image recording device has a higher recording resolution than the first image recording device or enables (in particular also in conjunction with an objective) a higher image resolution than the first image recording device. In particular, the second image recording device enables microscopic imaging of the surface and/or pictorial resolution of individual effect pigments.

Preferably, the first image recording device enables an enlargement factor of the surface that is greater than 0.2, preferably greater than 0.3, preferably greater than 0.4, preferably greater than 0.5 (this means that the image is reduced in relation to the actual size of the surface). Preferably, the first image recording device enables an enlargement or an enlargement factor of the surface with a factor that is less than 1.2, preferably less than 1.0, preferably less than 0.9, and particularly preferably less than 0.8.

The second image capture device preferably enables an enlargement and/or an enlargement factor of the surface, i.e., an enlargement of the image relative to the actual surface, by a factor that is greater than 2.0, preferably greater than 3.0, and preferably greater than 4.0.

Particularly preferably, the second image recording device enables an enlargement and/or an enlargement factor of the surface or the image of the surface by a factor that is less than 15, preferably less than 12, preferably less than 10, preferably less than 8, preferably less than 7, and preferably less than 6. Particularly preferably, the enlargement factor is approximately 5.

The first image recording device is preferably suitable and intended to record images of the surface that are suitable for characterizing visual properties caused by the effect pigments.

The applicant was able to determine that this enlargement factor of approximately 5 represents a good compromise between, on the one hand, not making the optics too complicated and, on the other hand, enabling a usable enlargement of the image (in particular also for examining the effect pigments).

In particular, the second image recording device should be suitable and intended to record images that are suitable for measuring or determining the properties of individual effect pigments from these images, such as their size, shape, orientation, color, and/or color gradient.

In a further advantageous embodiment, the apparatus has a housing within which the first radiation device, optionally the second radiation device, the first image recording device, and the second image recording device are arranged. Particularly preferably, this housing has an opening through which the first and, optionally, the second radiation device illuminate the surface to be examined. Preferably, this is the only opening in the housing through which light from outside can reach the image recording devices and/or through which radiation can escape from the housing.

In a preferred embodiment, the apparatus is a portable apparatus or an apparatus that can be carried by a user without aids.

Preferably, the weight of the apparatus is less than 3 kg, preferably less than 2 kg, and particularly preferably less than 1 kg. Preferably, a control device for controlling the radiation devices and/or the image recording devices is also arranged in the housing. Furthermore, a storage device for storing recorded images is also provided in the housing.

Particularly preferably, the above-mentioned objectives are integrated into this housing.

In a further advantageous embodiment, a first objective device is assigned to the first image recording device and/or a second objective device is assigned to the second image recording device, wherein the second objective device preferably has a greater objective length than the first objective device.

Preferably, at least one aperture is arranged in the optical path between the surface to be examined and the second image recording device. Preferably, several apertures are arranged in this optical path. Particularly preferably, at least one of these apertures is arranged in one of the objective devices and, in particular, in the second objective device.

Particularly preferably, the second objective device has a length (along the optical path) that is at least 1.5 times as long, preferably at least 2.0 times as long, as the length of the first objective device.

Particularly preferably, the two objectives extend in different directions and, particularly preferably, in directions perpendicular to each other. Particularly preferably the objectives extend in the same plane.

In a further advantageous embodiment, the first image recording device and the second image recording device are arranged in such a way that they enable the surface to be recorded at the same recording angle. In particular, the first and second image recording devices or their arrangement enable the surface to be observed from a substantially perpendicular direction. A substantially perpendicular observation direction is understood to mean that the observation angle deviates from an exactly perpendicular direction by no more than 10°, preferably no more than 7°, preferably no more than 5°, and preferably no more than 3°.

It would also be possible for the first and second image recording devices to enable or perform recording of the surface at different recording angles.

In a further advantageous embodiment, the apparatus has a first beam splitter device which is arranged between the image recording devices and the surface to be examined. This beam splitter device can be used to ensure that, for example, both image recording devices observe the surface from the same angle. This beam splitter device can be designed in such a way that it allows the same amount of light to reach both image recording devices.

However, it would also be possible and preferable for the beam splitter device to be designed in such a way that more light reaches the second image recording device. Preferably, the amount of radiation reaching the first image recording device and the amount of radiation reaching the second image recording device are in a ratio of between 1:1 and 1:5, preferably between 1:1 and 1:4, preferably between 1:1 and 1:3, and particularly preferably between 1:1.5 and 1:3.

In a further advantageous embodiment, the apparatus has a second beam splitter device which is arranged between the image recording devices and the surface. In this way, coupling to different receiving and/or image recording devices is possible at two locations.

Particularly preferably, the first beam splitter device and the second beam splitter device are arranged in an optical path between the surface and at least one image recording device and preferably in an optical path between the surface and both image recording devices in series.

In a further preferred embodiment, at least one beam splitter device is selected from a group of beam splitter devices comprising beam splitter plates, beam splitter cubes, and pellicles. A pellicle is an ultra-thin, ultra-light, semi-transparent mirror used in the light spot of an optical instrument to split the light beam into two parallel beams, both of which have reduced light intensity. Splitting the beam allows it to be used for several purposes simultaneously. The pellicle virtually eliminates beam and image duplication due to a non-coincident weak second reflection from the nominally non-reflective surface.

Preferably, the pellicle has a very thin membrane, and in particular a cellulose membrane and in particular a nitrocellulose membrane (or film) of optical quality, which is stretched and glued over a body, in particular a ring and in particular an aluminum ring. In its function, a pellicle beam splitter serves the same purpose as a conventional plate beam splitter. On closer inspection, a plate beam splitter (or “mirror-type” beam splitter) produces two reflected beams for a single input beam. One beam is a reflection from the first (or front) surface and the second from the second (or rear) surface.

The result is a so-called “ghost image” or secondary reflection. In addition, due to the thickness of the glass substrate (1-3 mm depending on size), plate beam splitters slightly shift the transmitted beam laterally from the input beam. For these reasons, plate beam splitters minimize these effects and offer the best performance when the glass thickness is minimal, the coated surface is aligned with the source, they are used in a collimated beam, and the rear surface is AR (anti-reflective) coated.

In a further advantageous embodiment, the apparatus has a third emission device which is suitable and intended to irradiate radiation onto the surface to be examined in a third emission direction characterized by a third emission angle.

Preferably, an irradiation angle at which a radiation device irradiates radiation onto the surface is between 30° and 60° relative to the perpendicular direction, preferably between 35° and 55°, preferably between 40° and 50°, and particularly preferably between 42° and 48°.

Preferably, the first radiation device and/or the second radiation device emits directional radiation. Preferably, the first radiation device and/or the second radiation device has a light source in the form of at least one white LED.

Preferably, an irradiation angle at which a radiation device irradiates radiation onto the surface is between 60° and 90° relative to the perpendicular direction, preferably between 65° and 85°, preferably between 70° and 80°, and particularly preferably between 72° and 78°. Preferably, this radiation device irradiates directional radiation. Preferably, the first radiation device and/or the second radiation device has a light source in the form of at least one white LED.

Preferably, an irradiation angle at which a radiation device irradiates radiation onto the surface is between 5° and 25° relative to the perpendicular direction, preferably between 10° and 20°, preferably between 12° and 18°, and particularly preferably between 14°and 16°. Preferably, this radiation device irradiates directional radiation. Preferably, the first radiation device and/or the second radiation device has a light source in the form of at least one white LED.

In a further preferred embodiment, diffuse illumination of the surface is also provided. White LEDs can also be used for this purpose. An integrating sphere can be used to achieve this diffuse illumination.

In this case, light is preferably irradiated onto the surface at at least three different angles.

The apparatus has preferably a fourth irradiation device which is suitable and intended to irradiate radiation onto the surface to be examined in a fourth irradiation direction characterized by a fourth irradiation angle. In this design, light is therefore irradiated onto the surface from at least four different directions.

In a further preferred embodiment, the apparatus has a further illumination device which is suitable and intended to illuminate the surface diffusely. Preferably, this further illumination device also has at least one white LED.

Preferably, a scattering surface, in particular in the form of a so-called Ulbricht sphere, is provided to generate this diffuse illumination. An Ulbricht sphere is a component of technical optics. It is used as a light source to achieve diffuse radiation from directional radiation or to collect radiation from highly divergent sources.

This is preferably an internally diffusely reflecting hollow sphere, in whose surface there is (often) an exit opening at right angle to a light entry opening. The light or radiation source is located in front of the light entry opening. The inner coating consists of materials with the best possible diffuse reflection properties. Barium sulfate (BaSO₄) is the preferred material. However, it is also possible to achieve favorable reflection properties over a wide wavelength range with optical PTFE.

A control device is preferably provided which ensures that only a maximum of one irradiation device irradiates the surface with radiation within a specified period of time.

In a further advantageous embodiment, the second image recording device enables an image resolution with a number of active pixels between 1500×1200 and 3000×2500, preferably between 2000×1500 and 2800×2300, and particularly preferably between 2300×1800 and 2700×2000.

Preferably, the pixel size is between 1.0 mm×1.0 mm and 4.0 mm×4.0 mm, preferably between 1.2 mm×1.2 mm and 3.0 mm×3.0 mm, and preferably between 1.5 mm×1.5 mm and 2.5 mm×2.5 mm.

In a further preferred embodiment, the focal length of an objective associated with the second image recording device is greater than 1.0 mm, preferably greater than 2.0 mm, preferably greater than 2.5 mm, preferably greater than 3.0 mm, preferably greater than 3.5 mm, preferably greater than 4.0 mm, and particularly preferably greater than 4.5 mm.

Preferably, the focal length of an objective associated with the second image recording device is less than 50 mm, preferably less than 40 mm, preferably less than 30 mm, preferably less than 20 mm, preferably less than 15 mm, preferably less than 10 mm, preferably less than 8.0 mm, preferably less than 7.0 mm, and particularly preferably less than 6.0 mm.

In a further preferred embodiment, the focal length of an objective associated with the first image recording device is greater than 2.0 mm, preferably greater than 3.0 mm, preferably greater than 4.0 mm, preferably greater than 6.0 mm, preferably greater than 8.0 mm, preferably greater than 10.0 mm, and particularly preferably greater than 12.0 mm.

Preferably, the focal length of an objective associated with the first image recording device is less than 50 mm, preferably less than 45 mm, preferably less than 40 mm, preferably less than 35 mm, preferably less than 30 mm, preferably less than 25 mm, preferably less than 20 mm, preferably less than 18.0 mm, and particularly preferably less than 16.0 mm.

These focal lengths have proven to be particularly favorable for corresponding good surface imaging (in particular when at the same time installation space is limited).

In a further preferred embodiment, the property of the effect pigments is selected from a group of properties comprising a size of the effect pigments, a geometric shape of the effect pigments, a color of the effect pigments, a curvature of the effect pigments, an orientation of the effect pigments, an inclination of the effect pigments within the surface, a manufacturer of the surface, a manufacturer of the effect pigments, a material of the effect pigments, and the like.

In a further preferred embodiment, the evaluation device is suitable and intended to determine the properties characteristic of the effect pigments using artificial intelligence.

Preferably, image evaluation of the images recorded in particular by the second image recording device is performed using artificial intelligence. Particularly preferably, a machine learning image evaluation model is created for the evaluation of the images.

The image evaluation model of machine learning is preferably based on an (artificial) neural network. The neural network is preferably a deep neural network (DNN), in which the parameterizable processing chain has a plurality of processing layers, and/or a so-called convolutional neural network (CNN) and/or a recurrent neural network (RNN).

Preferably, the data (to be processed), in particular the spatially resolved images (or data derived therefrom), are supplied to the image evaluation model or the (artificial) neural network as input variables. Preferably, the image evaluation model or the artificial neural network maps the input variables to output variables as a function of a parameterizable processing chain, wherein the output variables preferably comprise a type of effect pigments, a size of the effect pigments and/or individual effect pigments, a size range of the effect pigments and/or individual effect pigments, a number of effect pigments per unit area, a size variance of the effect pigments, an inclination of the and/or individual effect pigments, a curvature of the effect pigments, a color of the effect pigments, a curvature profile of the or individual effect pigments, or a type of effect pigments (i.e., whether they are metallic effect pigments, pearlescent pigments, interference pigments, or glitter pigments).

Preferably, the machine learning image evaluation model is/was trained using predetermined training data, wherein the training parameterizes the parameterizable processing chain.

In a preferred method, training data comprising a plurality of spatially resolved images (of examined surfaces with effect pigments) recorded by the at least one image recording device and, in particular, the second image recording device is used in the training process of the image evaluation model. This offers the advantage that the training process is already specifically tailored to the inspection device and/or image recording device (including its optics) used and/or to be used, and thus, for example, specific conditions of the specific apparatus, such as optical properties of the image recording device or specific lighting conditions in the inspection apparatus, can be directly taken into account.

Preferably, the spatially resolved images intended for use as training data (recorded by the at least one image recording device, i.e., the second image recording device) are provided with (surface) type and/or classification features.

In addition, parameters used for the optical settings when recording the individual images, for example with regard to the apertures or lenses used, or even the objectives used, can also be used to create the training data.

Preferably, the spatially resolved images are stored and/or used together with the surface types and/or effect pigment types and/or features characteristic of the effect pigments (color, material, manufacturer, type of effect pigments, etc.) and/or classification features as a training data set (in particular on a volatile and/or non-volatile storage device). Preferably, a plurality of training data sets are generated in this way.

The classification features may preferably be a type of effect pigment, a genus of effect pigments (i.e., whether they are metallic effect pigments, pearlescent pigments, interference pigments, or glitter pigments), a size of the effect pigments and/or individual effect pigments, a size range of the and/or individual effect pigments, a number of effect pigments per unit area, a size variance of the effect pigments, an inclination of the and/or individual effect pigments, a curvature of the effect pigments, a color of the effect pigments, a curvature profile of the or individual effect pigments of the manufacturer of the effect pigments or the surface, or even properties of further layers of the surface.

The use of a machine learning image evaluation model ensures that a (complex) combination of different features and/or reference ranges (in the training process) that is optimal for data processing, as well as features (or combinations of features) adapted to a wide variety of different surface types and/or effect pigment types, is identified or determined.

This offers the advantage that, when evaluating the at least one spatially resolved image using the trained image evaluation model, the characteristic parameters of the surface and/or the effect pigments, such as their size, color, inclination, density, etc., can then be determined with high precision.

In addition, the effect pigments may differ in further properties, such as a brightness, a dynamics, a density or a color gradient, or a colorfulness.

The effect pigments preferably have a middle particle area of between 15 mm² and 700 mm², preferably between 30 mm² and 500 mm².

The effect pigments may be selected, for example, from the following types:

The effect pigments could, for example, be metallic effect pigments (e.g., aluminum flakes). These preferably have a particle size between 5 and 50 μm. Smaller particles, in particular particles with a particle size between 5 and 20 μm, produce a smooth, fine metallic appearance. Larger particles (especially those with a particle size between 20 and 50 μm) produce a more intense, glittering effect.

Furthermore, the effect pigments could be pearlescent pigments, which are based on glimmer, titanium dioxide, or silicon dioxide, for example. These preferably have a particle size between 5 and 60 μm. Fine particles (in particular those with a particle size between 5 and 20 μm) create a subtle, silky sheen here. Coarser particles (in particular those with a particle size between 20 and 60 μm) offer stronger color shimmer and reflection effects.

Furthermore, the effect pigments could be interference pigments. These preferably have a particle size between 5 and 50 μm. They are often comparable to pearlescent pigments, as they are based on similar materials.

Finally, the effect pigments could be glitter pigments. These preferably have a particle size between 5 and 200 μm (or even larger). Such glitter pigments create striking glitter effects, which are often used in special paints or tuning paints.

The effect pigments may also have one or more oxide layers.

The effect pigments are preferably effect pigment flakes. These are preferably incorporated into a layer of the surface or the paint on the surface.

In a further preferred embodiment, the enlargement factor of at least the second image recording device is variable in order to enable adaptation to different surfaces.

In a further preferred embodiment, at least one of the image recording devices and/or at least one objective associated with at least one image recording device (and preferably both image recording devices and/or the objectives associated therewith) has an autofocus device. This is in particular helpful because the respective enlargement optics, in particular those associated with the second image recording device, have a relatively shallow depth of field.

In a further advantageous embodiment, the evaluation device has a memory in which reference data of effect pigments or effect pigment groups are stored. In addition, images or image data that have been recorded can also be stored in this memory device.

The present invention is further directed to a method for examining optical properties of surfaces, in particular surfaces coated with effect pigments, wherein a first radiation device irradiates radiation in a first irradiation direction characterized by a first irradiation angle onto the surface to be examined and, preferably, a second radiation device irradiates radiation in a second irradiation direction characterized by a second irradiation angle onto the surface to be examined (wherein the first and second irradiation angle preferably differ), and wherein a first image recording device records at least one spatially resolved image of the surface irradiated by at least one of the radiation devices.

According to the invention, a second image recording device records a spatially resolved image of the surface and, in particular, of the surface irradiated by at least one of the irradiation devices.

Preferably, the image recorded by the second image recording device is a color image, i.e., the second image recording device is preferably suitable and intended for recording color images. Preferably, the first image recording device is also suitable and intended for recording color images.

The present invention is further directed to a method for examining optical properties of surfaces and, in particular, surfaces provided with effect pigments, wherein a first radiation device irradiates radiation in a first irradiation direction characterized by a first irradiation angle onto the surface to be examined.

Preferably, a second radiation device also irradiates the surface to be examined with radiation in a second irradiation direction defined by a second irradiation angle.

Furthermore, a first image recording device records at least one spatially resolved image of the surface irradiated by the radiation device or by at least one of the radiation devices.

Furthermore, an evaluation device evaluates the image recorded by the second image recording device in order to determine at least one property that is characteristic of the effect pigments and/or of individual effect pigments.

In a further preferred method, the second image recording device records a higher-resolution image of the surface than the first image recording device, and in particular a microscopic image of the surface.

Particularly preferably, the second image recording device enlarges the recorded image by a predetermined factor (relative to the surface to be examined), which is preferably greater than 2, preferably greater than 3, and preferably greater than 4. This factor is preferably less than 40, preferably less than 30, preferably less than 25, preferably less than 20, preferably less than 15, preferably less than eight, and preferably less than 6.

Preferably, a radiation device illuminates the surface in two and preferably several different colors or wavelengths.

In a further preferred method, the first image recording device and the second image recording device record an image of the surface at the same recording angle.

In a further preferred method, the second image recording device enlarges the recorded image (relative to the actual surface) by more than 2 times, preferably more than 3 times, preferably more than 4 times, preferably more than 5 times, or equal to 5 times.

Preferably, the second image recording device enables an enlargement (relative to the surface) that is less than 20 times, preferably less than 15 times, preferably less than 10 times, preferably less than 8 times, and particularly preferably less than 7 times and particularly preferably less than 6 times.

In a further preferred method, the radiation reflected and/or scattered by the surface is split by a beam splitter before it reaches the second image recording device. Particularly preferably, the optical path from the surface to be examined to the image recording devices passes through at least two beam splitter devices.

Preferably, the surface is illuminated at at least three different angles and preferably at at least four different angles.

It is also preferred that light is irradiated onto the surface at an angle of 45° and that the radiation reflected from the surface is detected by a detection device. Preferably, a detection device is provided which detects an intensity of the radiation incident upon it.

Particularly preferably, the color with which at least one radiation device irradiates light onto the surface is changed. This is preferably done by a filter set and/or a filter wheel.

Preferably, the surface to be examined is recorded by the second image recording device with an exposure time that is greater than 1 ms, preferably greater than 2 ms, preferably greater than 4 ms, preferably greater than 6 ms, preferably greater than 8 ms, preferably greater than 10 ms, preferably greater than 12 ms, preferably greater than 14 ms, preferably greater than 16 ms, preferably greater than 18 ms, preferably greater than 20 ms, and preferably greater than 25 ms.

Preferably, the surface to be examined is recorded by the second image recording device with an exposure time that is less than 500 ms, preferably less than 400 ms, preferably less than 300 ms, preferably less than 200 ms, preferably less than 150 ms, preferably less than 120 ms, preferably less than 100 ms, and particularly preferably less than 90 ms and particularly preferably less than 85 ms.

Preferably, the apparatus and/or method described here is designed in such a way that both original surfaces, for example original surfaces of objects and in particular motor vehicles, can be examined, i.e. those surfaces which are present on the motor vehicle in its manufactured state, as well as those surfaces which have been applied subsequently (for example as a result of accidents).

Preferably, the surfaces to be examined are painted surfaces. Preferably, these surfaces have a thickness (perpendicular to the extension of the surface) that is greater than 20 mm, preferably greater than 40 mm, preferably greater than 60 mm, and particularly preferably greater than 80 mm. In a further preferred embodiment, the surfaces have a thickness that is less than 400 mm, preferably less than 350 mm, preferably less than 200 mm.

The surfaces to be examined are preferably composed of at least three layers, preferably at least four layers, and particularly preferably at least five layers. The surfaces to be examined are preferably composed of at most 12 layers, preferably at most 10 layers, and preferably at most 8 layers.

These specifications are of great importance with regard to the optical parameters of the second image recording device and/or the objective associated with the second image recording device. Preferably, the effect pigments are located in a middle layer of the surface to be examined.

### DETAILED DESCRIPTION OF THE INVENTION

Further advantages and practicalities can be found in the following description in conjunction with the drawings. In the drawings:

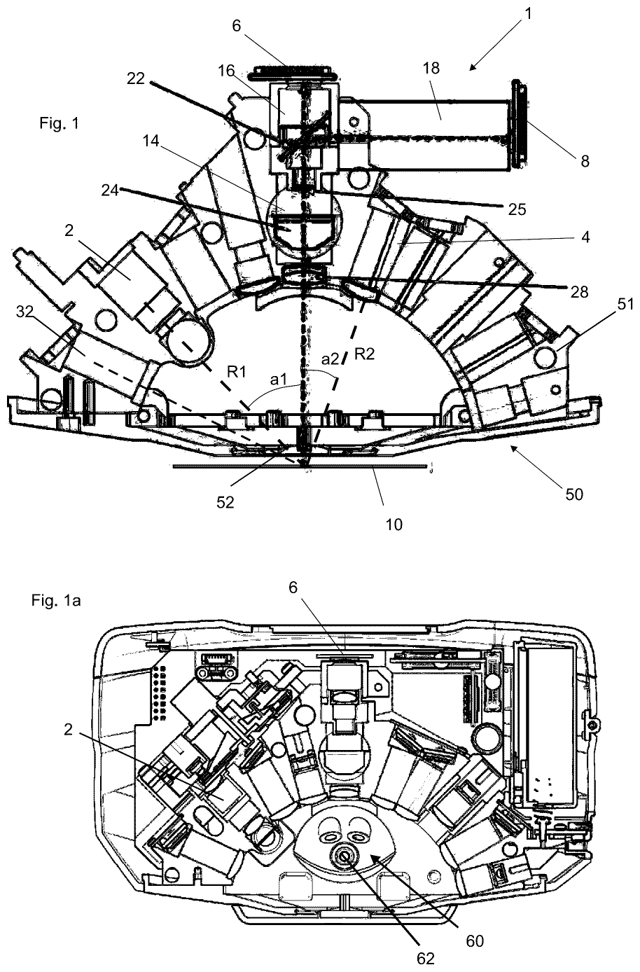

FIG. 1 shows a schematic representation of an apparatus according to the invention;

FIG. 1a shows a schematic representation of a further apparatus according to the invention.

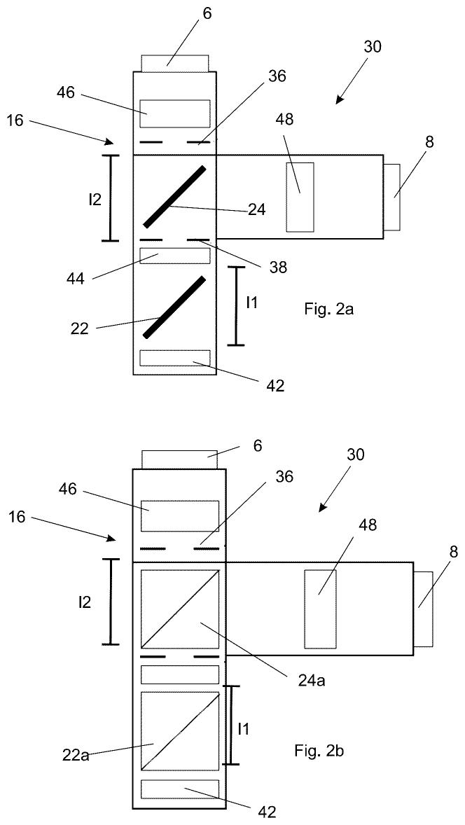

FIG. 2a-c show detailed representations of the apparatus from FIG. 1;

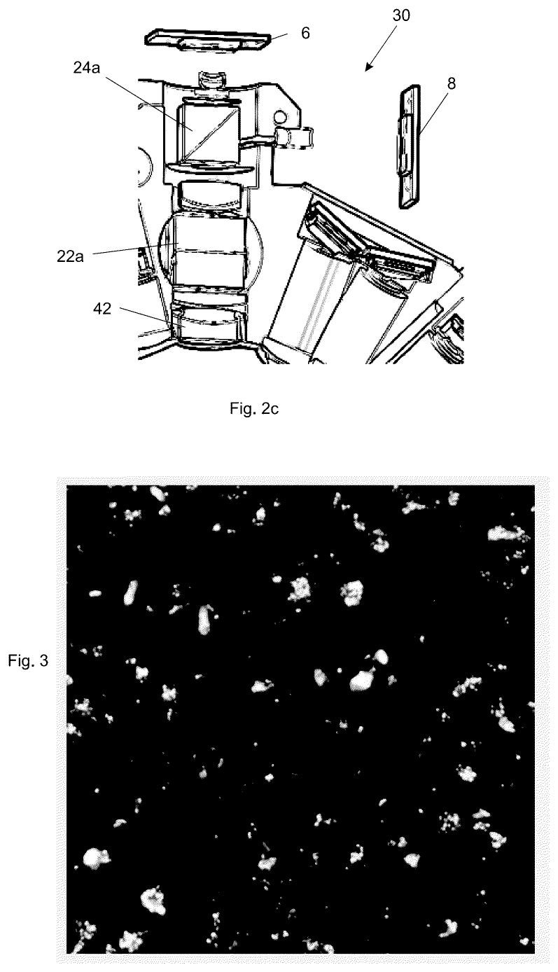

FIG. 3 shows a representation of an image recorded by the second image recording device; and

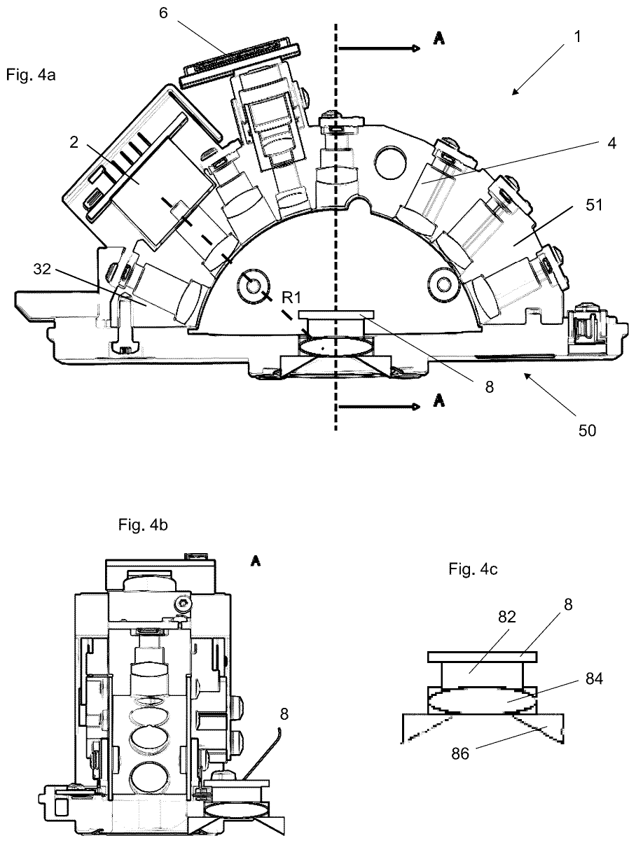

FIG. 4a-c show three views of a further embodiment of the apparatus according to the invention

### DETAILED DESCRIPTION OF THE INVENTION

FIG. 1 shows a schematic representation of an apparatus 1 according to the invention. It has an optical block 51 and a housing 50 in which the electrical and optical components described in detail below are arranged. The housing has an opening 52 through which a surface 10 to be examined can be illuminated or irradiated and through which the radiation reflected and/or scattered by the surface returns to the interior of the housing 50.

Reference numeral 2 denotes a first radiation device which irradiates radiation, and in particular light, onto the surface 10 in an irradiation direction R1 and at an irradiation angle a1 relative to the surface 10. Preferably, a filter wheel (not shown in detail) is provided, which is arranged in the beam path between the first radiation device 2 and the surface. This filter wheel preferably has a plurality of color filters, by which light of different colors or wavelengths can be irradiated onto the surface 10.

Reference numeral 4 denotes a second (optional) radiation device which irradiates radiation, and in particular light, onto the surface 10 in an irradiation direction R2 and at an irradiation angle a2 relative to the surface 10.

Reference numeral 32 denotes a third (optional) radiation device which irradiates radiation, and in particular light, onto the surface 10 in a further irradiation direction and at a further irradiation angle relative to the surface 10.

Reference numeral 6 denotes a first image recording device which is arranged in the vertical direction relative to the surface 10 and records a first image of this surface. For this purpose, the first image recording device preferably records the radiation scattered by the surface 10 (or a portion thereof).

Preferably, by this first image recording device 6 and the optics associated with it an image enlargement of approximately 0.7 is enabled. Preferably, the size of the corresponding observation spot is between 6.0 mm×4.0 mm and 12.0 mm×9.00 mm, preferably between 7.0 mm×5.0 mm and 9.0 mm and 7.0 mm.

Preferably, the image scale of this first image recording device is between 2.0 μm/pixel and 4.0 μm/pixel.

Reference numeral 8 denotes a second image recording device which, with optics described in more detail below, is preferably also arranged in such a way that it records an image of the surface illuminated by the at least one radiation device in a vertical direction. As explained above, the second image recording device enables a significantly higher resolution of the recorded image than the first image recording device. Reference numeral 25 denotes an aperture.

Preferably, by this second image recording device 8 and the optics associated with it an image enlargement of approximately 5 is enabled. Preferably, the size of the corresponding observation spot is between 0.9 mm×0.6 mm and 1.8 mm×1.6 mm, preferably between 1.0 mm×0.8 mm and 1.4 mm and 1.1 mm.

Preferably, the image scale of this second image recording device is between 0.3 μm/pixel and 0.55 μm/pixel.

Reference numeral 28 denotes a lens and, in particular, an achromatic lens, which preferably forms the entrance for the radiation originating from the surface to the image recording devices.

Preferably, a distance between this lens 28 and the surface 10 is greater than 20 mm, preferably greater than 30 mm, preferably greater than 40 mm, and particularly preferably greater than 45 mm. Preferably, a distance of this lens 28 and the surface is less than 90 mm, preferably less than 80 mm, preferably less than 70 mm, preferably less than 60 mm, and particularly preferably less than 55 mm.

FIG. 1a shows a further representation of an apparatus according to the invention, wherein the second image recording device is not shown here for reasons of clarity. This apparatus has a generating device 60 for generating diffuse radiation in the form of a so-called Ulbricht sphere (integrating sphere) 60. Reference numeral 62 denotes an illumination device such as a white light LED for illuminating the generating device 60.

FIG. 2a schematically shows the optical structure or optical arrangement that enables the images to be recorded by the two image recording devices 6 and 8. The light originating from the surface 10 runs here in a vertical line from the surface (not shown) upwards.

Reference numeral 42 denotes a first lens assembly through which the radiation originating from the surface passes.

Reference numeral 22 indicates a beam splitter which transmits a portion of the radiation and couples out a further portion of the radiation and reflects it to a further radiation detection device (not shown). This further radiation device is suitable and intended to detect an intensity of the radiation incident upon it. Preferably, this portion of the radiation is reflected in a direction perpendicular to the plane of the figure.

Reference numeral 44 denotes a second lens assembly through which the radiation originating from the surface passes. This second lens assembly is preferably arranged between the first beam splitter device 22 and a second beam splitter device 24.

Reference numeral l1 indicates a distance between the first lens assembly 42 and the second lens assembly. This distance is preferably greater than 10 mm, preferably greater than 12 mm, preferably greater than 14 mm, preferably greater than 16 mm, preferably greater than 18 mm, and particularly preferably greater than 20 mm. Furthermore, this distance l1 is preferably less than 50 mm, preferably less than 40 mm, preferably less than 35 mm, preferably less than 30 mm, and particularly preferably less than 25 mm. These distance limits were determined in extensive investigations by the applicant in order to achieve a particularly favorable design of the optical arrangement.

Reference numeral 24 denotes a beam splitter, referred as the first beam splitter device above, which splits the radiation incident upon it into a first portion that reaches the first image recording device 6 and a second portion (preferably larger than the first portion) that reaches the second image recording device 8.

Reference numeral 16 denotes a first objective device associated with the first image recording device 6, and reference numeral 18 denotes a second objective device associated with the second image recording device 8. It can be seen that the second objective device 18 is considerably longer than the first objective device 16.

Preferably, the second objective device is at least twice as long as the first objective device. Preferably, the second objective device is at most four times as long as the first objective device 16. Preferably, the second objective device 18 extends perpendicular to the first objective device 16.

A lens assembly 46 is arranged within the first objective device 16, and a second lens assembly 48 is arranged in the second objective device 18.

Overall, therefore, an optical arrangement 30 is provided which enables image recording by the first image recording device 6 and the second image recording device 8. Preferably, this optical arrangement 30 has at least two separate lens assemblies, preferably three separate lens assemblies, and particularly preferably four separate lens assemblies.

Reference numeral 36 denotes a first aperture, which is preferably arranged in the first objective device 16. Preferably, the first aperture 36 is arranged between the beam splitter device 24 and the first image recording device. Preferably, this aperture has a cross-section that is greater than 0.5 mm, preferably greater than 1.0 mm, preferably greater than 1.5 mm. Preferably, this aperture has a cross-section that is smaller than 10 mm, preferably smaller than 8.0 mm, preferably smaller than 6.0 mm, and particularly preferably smaller than 4.0 mm and particularly preferably smaller than 3.0 mm.

Reference numeral 38 denotes a second aperture, which is preferably arranged between the beam splitter plates. Preferably, this second aperture has a cross-section greater than 2.0 mm, preferably greater than 4.0 mm, preferably greater than 6.0 mm. Preferably, this second aperture has a cross-section that is less than 16 mm, preferably less than 14.0 mm, preferably less than 12.0 mm, and particularly preferably less than 10.0 mm and particularly preferably less than 9.0 mm.

Preferably, the aperture size of this second aperture is greater than 8 mm, preferably greater than 10 mm, preferably greater than 11 mm, and particularly preferably greater than 12 mm, particularly preferably greater than 14 mm, and particularly preferably greater than 15 mm.

Preferably, an aperture size of this second aperture 36 is less than 25 mm, preferably less than 22 mm, preferably less than 20 mm, preferably less than 18 mm, and particularly preferably less than 17 mm. Preferably, the first aperture 36 is arranged between the beam splitter device 24 and the second image recording device 8.

The reference numeral l2 indicates a distance between the lens assembly 44 and the first aperture.

This distance is preferably greater than 6 mm, preferably greater than 8 mm, preferably greater than 10 mm, preferably greater than 11 mm, preferably greater than 12 mm, and particularly preferably greater than 14 mm. Furthermore, this distance is preferably less than 40 mm, preferably less than 30 mm, preferably less than 25 mm, preferably less than 20 mm, and particularly preferably less than 17 mm. These distance limits were determined in extensive investigations by the applicant in order to achieve a particularly favorable design of the optical arrangement.

FIG. 2b shows a further embodiment of the optical structure. In this embodiment, beam splitter cubes 22a, 24a are used instead of beam splitter plates 22, 24.

FIG. 2c shows the optical setup inside the housing of the apparatus.

FIG. 3 shows an example of an image recorded by the second image recording device. This image was recorded with a free passage of the first lens group of 16 mm and an exposure time of 30 ms.

A plurality of individual effect pigments can be seen here. Using suitable image analysis and, if necessary, artificial intelligence (AI), a wide variety of data on the effect pigments can be output. For example, a color of the effect pigments can be determined, or the proportion of those effect pigments that have a certain color.

Furthermore, the number of effect pigments per unit area can be determined. In addition, values such as the size of individual effect pigments or the average size of the effect pigments can be determined. The curvature of the effect pigments can also be determined, or values that are characteristic of the color behavior of the effect pigments, such as how they behave when illuminated from different directions.

In doing so, an AI can preferably draw on a very large number of images, as shown in FIG. 3, in order to be able to make objective statements about the effect pigments.

FIGS. 4a-4c show a further embodiment of an apparatus 1 according to the invention. Here, too, a first image recording device 6 and a second image recording device 8 are provided. Preferably, the second image recording device is an image recording device with an autofocus unit and/or the image recording device is autofocus-capable.

In the embodiments shown in FIGS. 4a-4c, however, the second image recording device 8 is arranged laterally adjacent to the first image recording device 6, as can be seen in FIG. 4b. Preferably, the second image recording device observes a slightly different or offset area of the surface to be examined compared to the first image recording device.

In this embodiment, it is proposed that the second image recording device be designed as a separate unit. Reference numeral 82 denotes an objective 82 with a lens 84. Reference numeral 86 denotes an illumination device for illuminating the surface. This illumination device is preferably designed as ring illumination, which preferably at least partially surrounds the lens 84 with respect to the observation direction. Preferably, this illumination device is equipped with at least one and particularly preferably with a plurality of LEDs.

Preferably, therefore, the second image recording device 8 also observes the surface 10 from a perpendicular direction, but preferably, as mentioned above, a laterally offset area of the surface 10.

It should be noted that all features described with reference to the method are also disclosed in a corresponding manner for the apparatus, which means in particular that the corresponding apparatus has devices that are suitable and intended for carrying out the respective methods. Furthermore, features described with reference to the apparatus are also applicable to the method or methods. This means that the methods are carried out using the corresponding apparatus features.

The applicant reserves the right to claim all features disclosed in the application documents as essential to the invention, provided that they are new in relation to the prior art, either individually or in combination. It should also be noted that the individual figures also describe features which may be advantageous in themselves. The skilled person will immediately recognize that a particular feature described in a figure may be advantageous even without adopting other features from that figure. Furthermore, the skilled person will recognize that advantages may also result from a combination of several features shown in individual or different figures.

1. An apparatus for examining optical properties of surfaces, comprising a first radiation device which is configured to irradiate radiation onto the surface to be examined in a first irradiation direction (R1) characterized by a first irradiation angle (a1), a second radiation device which is configured to irradiate radiation onto the surface to be examined in a second irradiation direction (R1) characterized by a second irradiation angle (a2), and with a first image recording device which is configured for recording a spatially resolved image of the surface irradiated by at least one of the irradiation devices,
wherein
the apparatus has a second image recording device which is configured for recording a spatially resolved image of the surface and, in particular, of the surface irradiated by at least one of the irradiation devices.

2. The apparatus according to claim 1,
wherein
the second image recording device is configured to enable a higher recording resolution than the first image recording device and, in particular, the second image recording device is configured to enable a microscopic recording of the surface.

3. The apparatus according to claim 1,
wherein
the apparatus has a housing within which the first radiation device, the second radiation device, the first image recording device, and the second image recording device are arranged, wherein this housing preferably has at least one opening through which the first and second radiation device illuminate the surface to be examined.

4. The apparatus according to claim 1,
wherein
the first image recording device is assigned a first objective device and the second image recording device is assigned a second objective device, wherein the second objective device preferably has a greater objective length than the first objective device.

5. The apparatus according to claim 1,
wherein
the first image recording device and the second image recording device are arranged in such a way that they enable the surface to be recorded at the same recording angle, or the first image recording device and the second image recording device are arranged in such a way that they enable two different areas of the surface to be recorded.

6. The apparatus according to claim 1,
wherein
the apparatus has a first beam splitter device which is arranged between the image recording devices and the surface.

7. The apparatus according to claim 6,
wherein
the apparatus has a second beam splitter device which is arranged between the image recording devices and the surface, wherein the first beam splitter device and the second beam splitter device are preferably arranged in series in an optical path between the surface and at least one image recording device and preferably between the surface and both image recording devices.

8. The apparatus according to claim 1,
wherein
the apparatus comprises a third irradiation device which is configured to irradiate radiation onto the surface to be examined in a third irradiation direction characterized by a third irradiation angle, and the apparatus has a fourth irradiation device which is configured to irradiate radiation onto the surface to be examined in a fourth irradiation direction characterized by a fourth irradiation angle.

9. The apparatus according to claim 1,
wherein
the second image recording device enables an image resolution that is higher than 2 MP, preferably higher than 3 MP, preferably higher than 4 MP, and particularly preferably higher than 5 MP.

10. The apparatus according to claim 1,
wherein
the second image recording device enables an enlargement that is greater than 2×, preferably greater than 4×, and preferably greater than or equal to 5×, and/or the second image recording device is configured to enable enlargement that is less than 20 times, preferably less than 15 times, preferably less than 10 times, and preferably less than 8 times.

11. The apparatus according to claim 1,
wherein
a focal length of an objective associated with the second image recording device is greater than 1 mm, preferably greater than 1.5 mm, preferably greater than 2.0 mm, preferably greater than 2.5 mm and preferably greater than 3.0 mm and particularly preferably greater than 3.5 mm and particularly preferably greater than 4.0 mm and/or a focal length of an objective associated with the second image recording device is less than 50 mm, preferably less than 40 mm, preferably less than 30 mm, preferably less than 20 mm, preferably less than 15 mm, preferably less than 10 mm, and particularly preferably less than 6 mm.

12. A method for examining optical properties of surfaces, in particular surfaces provided with effect pigments, wherein a first radiation device irradiates radiation onto the surface to be examined in a first irradiation direction (R1) characterized by a first irradiation angle (a1), and a second radiation device irradiates the surface to be examined with radiation in a second irradiation direction (R1) characterized by a second irradiation angle (a2), and a first image recording device records at least one spatially resolved image of the surface irradiated by at least one of the irradiation devices,
wherein
a second image recording device records a spatially resolved image of the surface and, in particular, of the surface irradiated by at least one of the irradiation devices.

13. The method according to claim 12,
wherein
the second image recording device records a higher-resolution image of the surface and, in particular, a microscopic image of the surface.

14. The method according to claim 12,
wherein
the first image recording device and the second image recording device record an image of the surface at the same recording angle.

15. The method according to claim 12,
wherein
the second image recording device performs an enlargement of the recorded image that is greater than 2 times, preferably greater than 4 times, and preferably greater than or equal to 5 times, and/or the second image recording device enables an enlargement that is less than 20 times, preferably less than 15 times, preferably less than 10 times, and preferably less than 8 times.

16. The apparatus according to claim 2,
wherein
the apparatus has a housing within which the first radiation device, the second radiation device, the first image recording device, and the second image recording device are arranged, wherein this housing preferably has at least one opening through which the first and second radiation device illuminate the surface to be examined.

17. The apparatus according to claim 2,
wherein
the first image recording device is assigned a first objective device and the second image recording device is assigned a second objective device, wherein the second objective device preferably has a greater objective length than the first objective device.

18. The apparatus according to claim 2,
wherein
the first image recording device and the second image recording device are arranged in such a way that they enable the surface to be recorded at the same recording angle, or the first image recording device and the second image recording device are arranged in such a way that they enable two different areas of the surface to be recorded.

19. The apparatus according to claim 2,
wherein
the apparatus has a first beam splitter device which is arranged between the image recording devices and the surface.

20. The apparatus according to claim 19,
wherein
the apparatus has a second beam splitter device which is arranged between the image recording devices and the surface, wherein the first beam splitter device and the second beam splitter device are preferably arranged in series in an optical path between the surface and at least one image recording device and preferably between the surface and both image recording devices.
